(19) United States
(12) Patent Application Publication
(10) Pub. No.: US 2006/0280307 A1
(43) Pub. Date: Dec. 14, 2006

(54) Data transmission apparatus and data reception apparatus

(76) Inventors: Tsuyoshi Ikushima, Nara (JP); Masaru Fuse, Osaka (JP); Satoshi Furusawa, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/447,878

(22) Filed: Jun. 7, 2006

(30) Foreign Application Priority Data
Jun. 10, 2005 (JP) 2005-170918

(51) Int. Cl. H04L 9/00

(52) U.S. Cl. 380/277

(57) ABSTRACT

There provided are transmission and reception apparatuses which can realize performing key distribution and encrypted communication in a simultaneous manner. A transmission apparatus overlaps minute amplitude modulation based on a random number signal on a multi-level signal generated based on information data and key information. A reception apparatus, in addition to data identification, performs, by using 2 threshold values between which a sufficiently larger interval than a modulation amplitude by a random number is provided, 3 kinds of identification for the random number signal: “1”, “0”, and “identification impossible”, sends back information of bits with which the identification has succeeded, and shares the sent bits as a new key. Thus, the common device including the transmission and reception apparatuses can realize performing the key distribution and the encrypted communication in the simultaneous manner.

### BACKGROUND OF THE INVENTION

1. Field of the Invention

The present invention relates to apparatuses for performing secret communication in order to prevent illegal eavesdropping and interception by a third party. More particularly, the present invention relates to apparatuses for performing data communication through selecting and setting a specific encoding/decoding (modulating/demodulating) method between a legitimate transmitter and a legitimate receiver.

2. Description of the Background Art

Conventionally, in order to perform communication only between authorized parties, there has been generally adopted a structure for realizing secret communication by sharing original information (key information) for encoding/decoding between transmission and reception ends and based on the original information, by performing an operation/inverse operation on information data (plain text) to be transmitted, in a mathematical manner.

On the other hand, in recent years, there have been proposed several encryption methods which make active utilization of physical phenomena in a transmission line. As one of these methods, there is a method called “Y-00 protocol” in which cipher communication is performed by utilizing quantum noise generated in an optical transmission line. Examples of a transmission apparatus and a reception apparatus are disclosed in Japanese Laid-Open Patent Publication No. 2005-57313 (hereinafter, referred to as a patent document 1).

FIG. 13 is a block diagram illustrating an exemplary configuration of conventional transmission and reception apparatuses using the Y-00 protocol. In FIG. 13, a transmission section 90001 includes a first multi-level code generation section 911, a multi-level processing section 912, and a modulator section 913. A reception section 90002 includes a demodulator section 915, a second multi-level code generation section 914, and an identification section 916. First, the transmission section 90001 and the reception section 90002 previously hold first key information 91 and second key information 96, respectively, which contain a common content. Based on the first key information 91, the first multi-level code generation section 911 generates as a multi-level code sequence 92 a multi-level pseudo-random number sequence having M values from “0” to “M−1”.

Based on values of information data 90 and the multi-level code sequence 92, the multi-level processing section 912 generates a multi-level signal 93, which is an intensity-modulated signal, by using a signal format shown in FIG. 14. In other words, the multi-level processing section 912 divides a signal intensity of the multi-level code sequence 92 into 2M levels, makes M combinations (modulation methods), each of which is made of 2 levels, and assigns “0” of the information data 90 to one level of each combination and “1” to the other level of the each combination. With respect to all the 2M levels, the multi-level processing section 912 assigns levels corresponding to “0” and “1” of the information data 90 so as to be evenly distributed.

In example of FIG. 14, “0” and “1” are alternately assigned. Based on the inputted multi-level code sequence 92, the multi-level processing section 912 selects one combination of levels, and outputs the multi-level signal 93 having the level. In the patent document 1, the first multi-level code generation section 911 is referred to as “a transmission pseudo-random number generation section”; the multi-level processing section 912 as “a modulation method designation section” and “a laser modulation driving section”; the modulator section as “a laser diode”; the demodulator section 915 as “a photodetector”; the second multi-level code generation section 914 as “a reception pseudo-random number generation section”; and the identification section 916 as “a determination circuit”.

Examples of a signal change in a case of M=4 are shown in FIGS. 15A, 15B, 15C, 15D, 15E, 15F, and 15G. For example, in a case where a value of the information data 90 is changed to “0111” (refer to FIG. 15A) and a value of the multi-level code sequence 92 is changed to “0321” (refer to FIG. 15B), the multi-level signal 93 is changed as shown in FIG. 15C. The modulator section 913 converts the multi-level signal 93 to a modulated signal 94, which is an optical intensity-modulated signal, to be transmitted via an optical transmission line 910.

The demodulator section 915 photoelectric-converts the modulated signal 94, which has been transmitted via the optical transmission line 910, to be outputted as a multi-level signal 95. Based on the second key information 96, the second multi-level code generation section 914 generates a multi-level code sequence 97 which is a same multi-level pseudo-random number sequence as the multi-level code sequence 92. Based on the value of the multi-level code sequence 97, the identification section 916 determines which one of combinations (modulation methods) of signal levels shown in FIG. 14 is used and performs binary identification for 2 signal levels of the combination. Specifically, based on a value of the multi-level code sequence 97, the identification section 916 sets an identification level as shown in FIG. 15E and determines whether the multi-level signal 95 is larger (above) or smaller (below) than the identification level. In this example, the identification section 916 performs identification of being “below, below, above, and below”.

Next, the identification section 916 determines that when the multi-level code sequence 97 is an even number, a below side is “0” and an above side is “1” and that when the multi-level code sequence 97 is an uneven number, the below side is “1” and the above side is “0”, and outputs information data 98. In this example, since the multi-level code sequence 97 is made of “an even number, an uneven number, an even number, and an uneven number” in order, the information data 98 is “0111”. Although the multi-level signal 95 includes noise, the transmission section 90001 can suppress generation of error in the binary identification to a negligible extent by selecting signal intensity in an appropriate manner.

Next, anticipated eavesdropping will be described. An eavesdropper attempts to decrypt the information data 90 or the first key information 91 from the modulated signal 94 without having key information which a transmitter and a receiver share. Since the eavesdropper has no key information, the eavesdropper cannot use a reception method based on the binary identification, which a legitimate receiver performs by using the reception section 90002. Therefore, the eavesdropper is assumed to perform multi-level identification, by using a multi-level identification section 922, of a multi-level signal 81 which is obtained by photoelectric conversion by means of a demodulator section 921, and to decrypt an obtained received sequence 82 by means of a decryption processing section 923, thereby trying to decrypt the information data 90 and the first key information 91.

In this case, when the photoelectric conversion is performed by means of a photodetector of the demodulator section 921, shot noise is generated and overlapped on the multi-level signal 81. It is known that this shot noise is invariably generated due to a principle of quantum mechanics. Here, if an interval between signal levels (hereinafter, referred to as a step width) is made sufficiently smaller than levels of the shot noise, possibility that the multi-level signal 81 received by identification error has various multi-levels other than a correct signal level cannot be ignored. Therefore, because the eavesdropper is required to perform decryption processing in consideration of possibility that the correct signal level may be a value other than the signal level obtained by the identification, a calculation amount required for the decryption processing increases as compared to a case where there is no identification error, resulting in an improvement in safety against the eavesdropping.

Although the conventional transmission apparatus and reception apparatus shown in FIG. 13 are supposed to previously have the first key information 91 and the second key information 96, when in real communication, lost synchronization of the key information occurs, redelivering the key information may be required. However, the conventional transmission apparatus and reception apparatus shown in FIG. 13 have a problem of not having a function of redelivering the key information.

### SUMMARY OF THE INVENTION

Therefore, an object of the present invention is to solve the above problem and to provide a transmission apparatus and a reception apparatus which can realize performing key distribution and encrypted communication in a simultaneous manner.

The present invention is directed to a data transmission apparatus for performing secret communication of information data. In order to achieve the above object, the data transmission apparatus comprises: a multi-level code generation section for, by using predetermined key information, generating a multi-level code sequence in which a signal level changes so as to be substantially random numbers; a multi-level processing section for combining the multi-level code sequence and the information data in accordance with predetermined processing and generating a multi-level signal having a level corresponding to a level of a combination of the multi-level code sequence and the information data; a modulator section for generating a modulated signal in a predetermined modulation method based on the multi-level signal; a random number generation section for generating a random number signal; and a key sharing section for selecting a part of bits from the random number signal based on a selected modulated signal transmitted from a reception end, accumulating the selected bits, and when a predetermined condition is satisfied, outputting the selected bits as new key information, wherein the modulated signal is amplitude-modulated based on the random number signal in a predetermined period.

Preferably, the key sharing section comprises: a selected-signal demodulator section for demodulating the selected modulated signal, in the predetermined modulation method, to be outputted as a selected signal; a key accumulation control section for selecting a part of bits from the random number signal based on the selected signal and outputting the selected bits; and a key accumulation section for outputting the key information, accumulating the selected bits, and when a predetermined condition is satisfied, outputting the selected bits as new key information.

Preferably, the data transmission apparatus further comprises an amplitude control signal generation section for outputting an amplitude control signal, based on the random number signal, which determines an amplitude of the information data, and an amplitude modulator section, which is provided upstream of the multi-level processing section, for amplitude-modulating the information data, based on the amplitude control signal, to be outputted.

The data transmission apparatus may further comprise an amplitude control signal generation section for outputting an amplitude control signal, based on the random number signal, which determines an information amplitude of the multi-level signal, and an amplitude modulator section, which is provided between the multi-level processing section and the modulator section, for amplitude-modulating the multi-level signal, based on the amplitude control signal, to be outputted.

The data transmission apparatus may further comprise an amplitude control signal generation section for outputting an amplitude control signal, based on the random number signal, which determines an information amplitude of the modulated signal, and an amplitude modulator section, which is provided downstream of the modulator section, for amplitude-modulating the modulated signal, based on the amplitude control signal, to be outputted.

A magnitude of an amplitude modulation based on the random number signal is sufficiently smaller than the information amplitude of the multi-level signal. And the predetermined period is a same period as a period in which the information data is transmitted.

Preferably, the data transmission apparatus further comprises a control signal generation section for outputting to the multi-level code generation section a control signal of a predetermined type.

Also the present invention is directed to a data reception apparatus for performing secret communication of information data. In order to achieve the above object, the data reception apparatus comprises a demodulator section for receiving from a transmission end a modulated signal in a predetermined modulation method, demodulating the received modulated signal, and outputting a multi-level signal; a multi-level code generation section for, by using predetermined key information, generating a multi-level code sequence in which a signal level changes so as to be substantially random numbers; a multi-level identification section for identifying the multi-level signal based on the multi-level code sequence and for outputting the information data; and a key sharing section for attempting identification of a random number signal generated at the transmission end from the multi-level signal in a predetermined period, accumulating, when the identification succeeds, a resultant as selected bits, outputting, when a predetermined condition is satisfied, the selected bits as new key information, and outputting to the transmission end a selected modulated signal indicating a position of the bits with which the identification has succeeded.

Preferably, the key sharing section comprises: a key identification section for attempting identification of the random number signal from the multi-level signal in a predetermined period, and outputting, when the identification succeeds, a resultant as selected bits, and outputting a selected modulated signal indicating a position of the bits with which the identification has succeeded; a key accumulation section for outputting the key information, accumulating the selected bits, and when a predetermined condition is satisfied, out putting the selected bits as new key information; and a selected-signal modulator section for modulating the selected signal, in a predetermined modulation method, to be outputted as a selected modulated signal.

A magnitude of amplitude modulation based on the random number signal is sufficiently smaller than an information amplitude of the multi-level signal. And the predetermined period is a same period as a period in which the information data is transmitted.

The data reception apparatus further comprises a control signal reproduction section for reproducing a control signal of a predetermined type from the multi-level signal.

Data communication apparatuses according to the present invention, based on key information, encodes/modulates information data to a multi-level signal to be transmitted; based on the key information, demodulates/decodes the received multi-level signal; optimizes a signal-to-noise power ratio of the multi-level signal; and in addition, overlaps amplitude modulation on the multi-level signal based on a random number signal. Thus, the data communication apparatuses can provide a secret communications system, having a simple configuration where it is unnecessary to provide a separate encryption key distribution system, which realizes performing transmission of cipher text and distribution of key information in a simultaneous manner by using the transmission apparatus and the reception apparatus.

And the amplitude modulation based on the random number signal is overlapped on a control signal, where by it is made possible to transmit not only the cipher text and the encryption key but also various control signals such as a timing signal by using a transmission and a reception sections. Therefore, providing the separate encryption key distribution system is unnecessary, there by simplifying the configuration of the secret communications system.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating an exemplary configuration of a data communications device according to a first embodiment of the present invention;

FIG. 2 is a diagram explaining signal levels in Yuen-Kim key distribution protocol;

FIGS. 3A, 3B, and 3C are diagrams explaining signal waveforms used in the data communications device according to the first embodiment of the present invention;

FIG. 4 is a diagram showing a relationship of correspondence between a relative value of a received signal level of each identification level and an identification result;

FIG. 5 is a block diagram illustrating a second exemplary configuration of the data communications device according to the fist embodiment;

FIG. 6 is a block diagram illustrating a third exemplary configuration of the data communications device according to the fist embodiment;

FIG. 7 is a block diagram illustrating a fourth exemplary configuration of the data communications device according to the fist embodiment;

FIG. 8 is a block diagram illustrating an exemplary configuration of a data communications device according to a second embodiment of the present invention;

FIGS. 9A, and 9B are diagrams explaining waveforms used in the data communications device according to the second embodiment of the present invention;

FIG. 10 is a block diagram illustrating an exemplary configuration of a data communications device according to a third embodiment of the present invention;

FIGS. 11A, 11B, and 11C are diagrams explaining wave forms used in the data communications device according to the third embodiment of the present invention;

FIG. 12 is a block diagram illustrating a second exemplary configuration of the data communications device according to the third embodiment of the present invention;

FIG. 13 is a block diagram illustrating an exemplary configuration of a conventional data communications device;

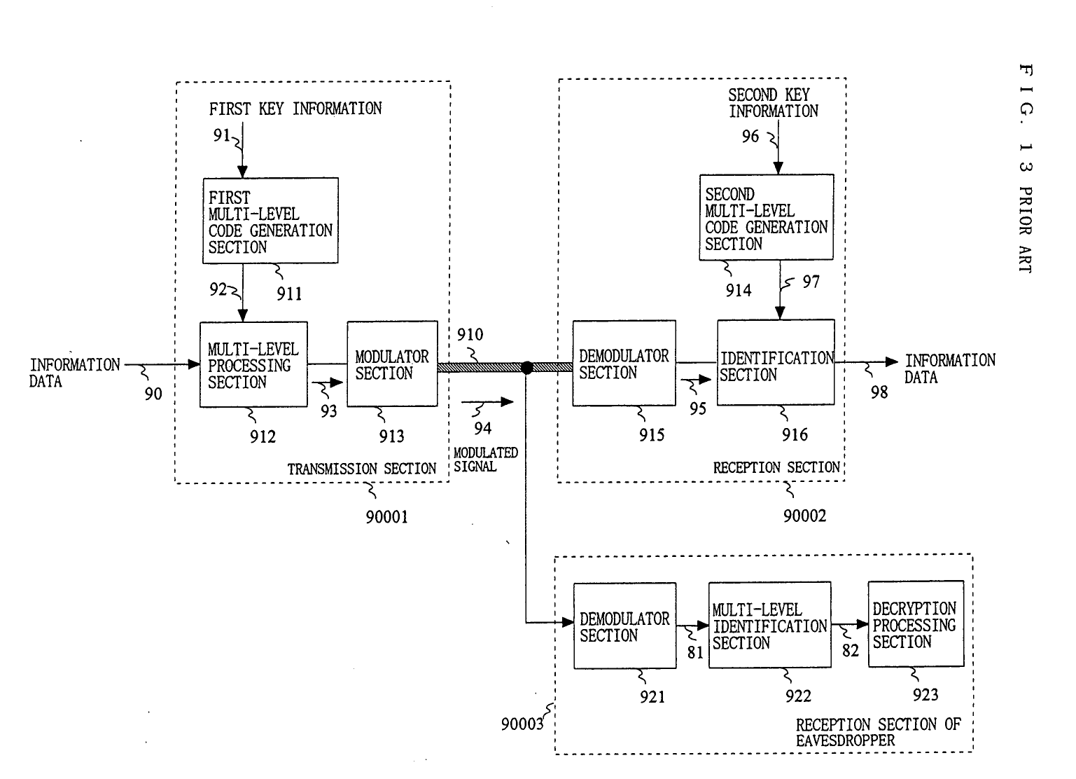

FIG. 14 is a diagram explaining arrangement of signal points in the conventional data communications device; and

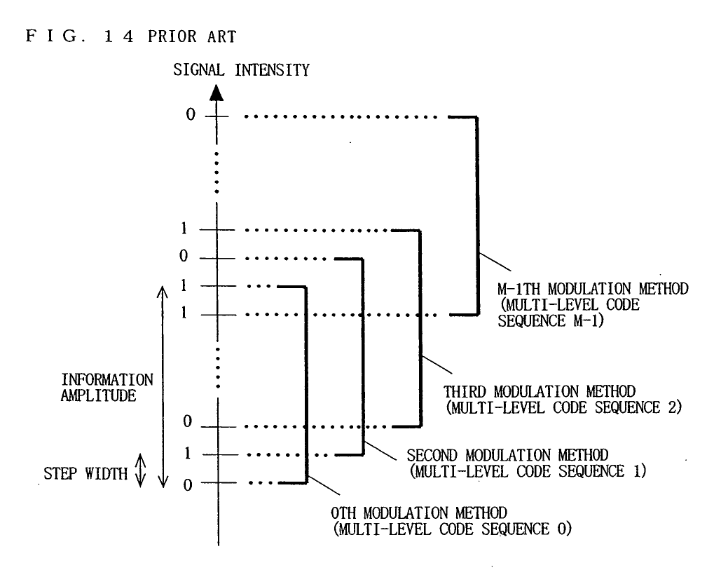

FIGS. 15A, 15B, 15C, 15D, 15E, 15F, and 15G are diagrams explaining waveforms used in the conventional data communications device.

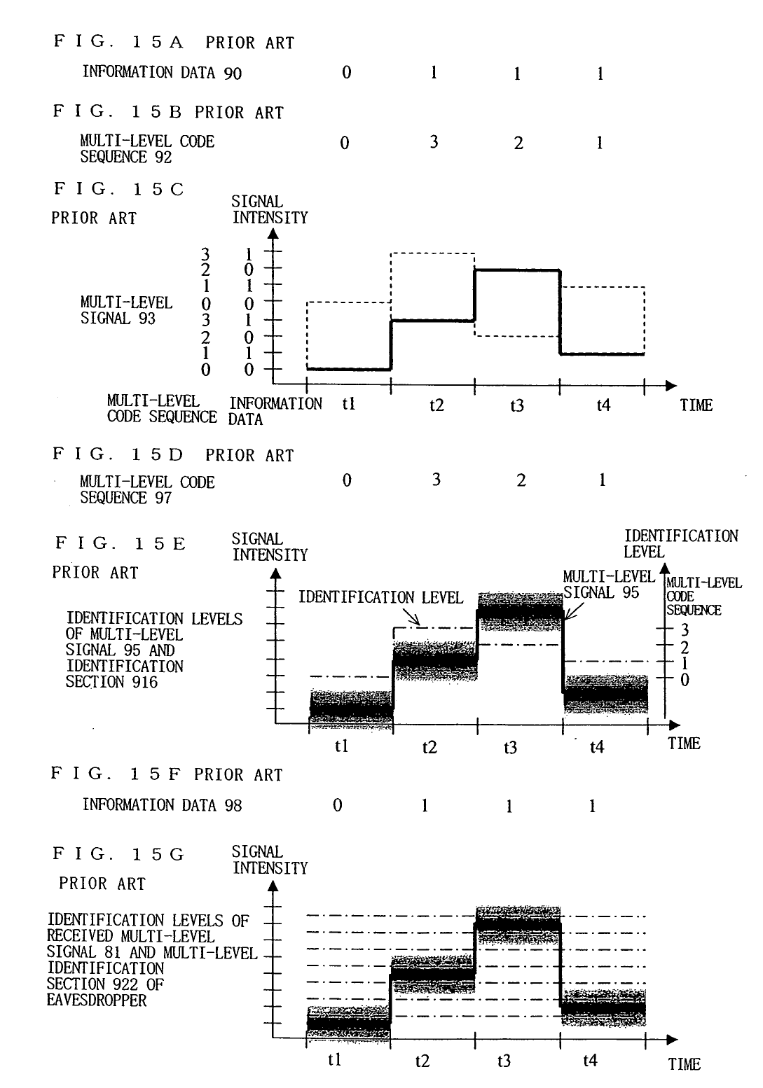

### DESCRIPTION OF THE PREFERRED EMBODIMENTS

(First Embodiment)

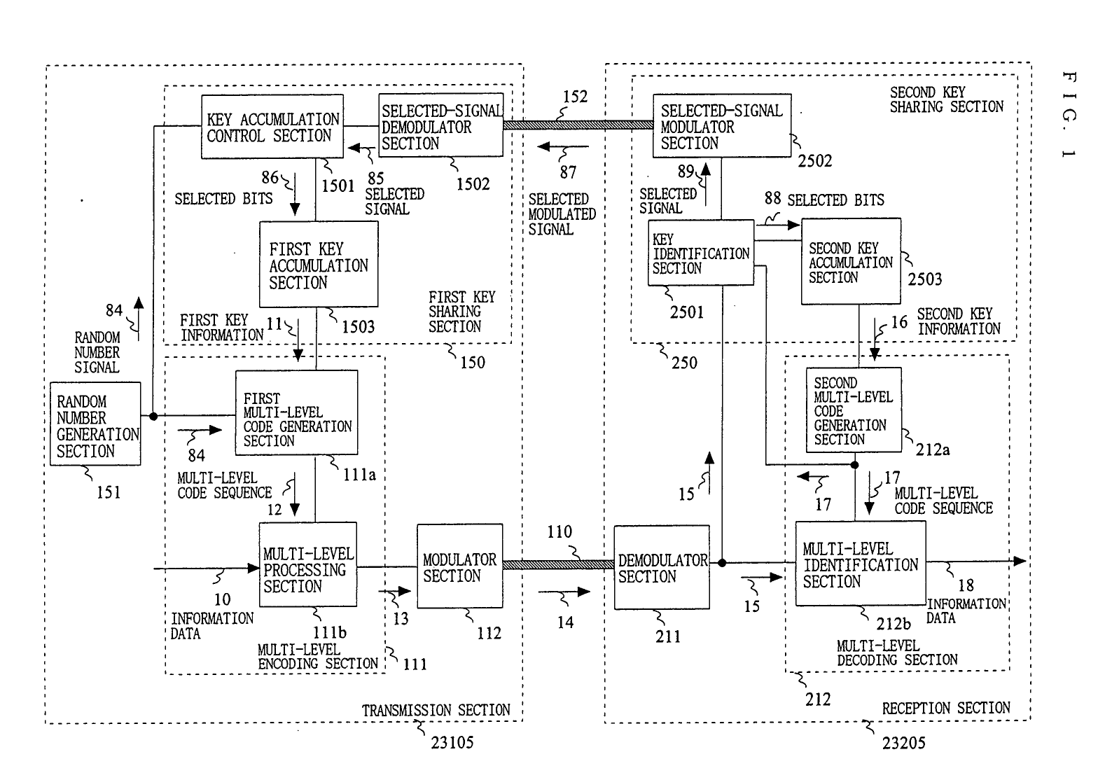

FIG. 1 is a block diagram illustrating an exemplary configuration of a data communications device according to a first embodiment of the present invention. In FIG. 1, the data communications device includes a transmission section 23105, a reception section 23205, a transmission line 110, and a selected-signal transmission line 152. The transmission section 23105 includes a multi-level encoding section 111, a modulator section 112, a first key sharing section 150, and a random number generation section 151. The reception section 23205 includes a demodulator section 211, a multi-level decoding section 212, and a second key sharing section 250. The multi-level encoding section 111 includes a first multi-level code generation section 111a and a multi-level processing section 111b. The multi-level decoding section 212 includes a second multi-level code generation section 212a and a multi-level identification section 212b. The first key sharing section 150 includes a key accumulation control section 1501, a selected-signal demodulator section 1502, a first key accumulation section 1503. The second key sharing section 250 includes a key identification section 2501, a selected-signal modulator section 2502, and a second key accumulation section 2503.

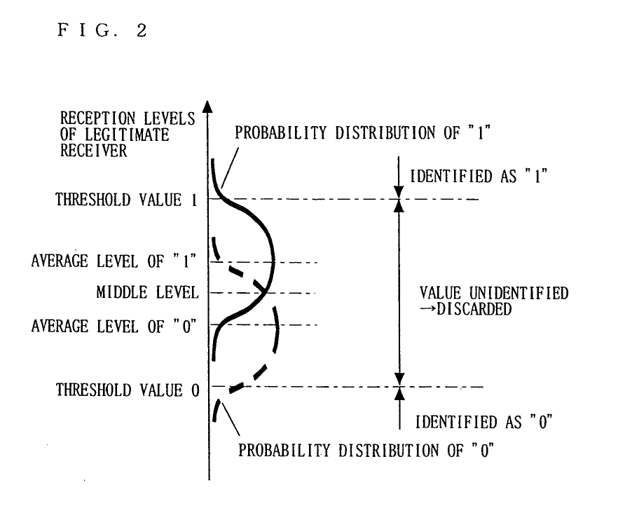

In the present embodiment, transmission of cipher text and distribution of key information used for generating a multi-level code are performed in a common transmission section and a common reception section. For the distribution of the key information, a method called “Yuen-Kim key distribution protocol” is used. First, with reference to FIG. 2, the Yuen-Kim protocol will be described. FIG. 2 is a diagram explaining signal levels in the Yuen-Kim protocol.

In the distribution of the key information, the data communications device is required to generate conditions under which only a legitimate receiver can receive correct key information and an eavesdropper cannot receive the correct key information. Here, considered is a case where an S/N ratio of a signal transmitted from a transmitter to the legitimate receiver is small and noise overlapped on the signal is quantum noise generated by an optical device or noise generated inside of a reception apparatus. In such a case, because there is no correlation between noise overlapped on a received signal of the legitimate receiver and noise overlapped on a received signal of the eavesdropper, as a result, there is no correlation between reception levels of the legitimate receiver and the eavesdropper. The Yuen-Kim key distribution protocol utilizes this scheme.

First, based on random numbers, the transmitter modulates a signal. As shown in FIG. 2, the transmitter sets a difference between signal levels corresponding to “1” and “0” so as to be sufficiently smaller than a noise level. When the legitimate receiver receives this signal, because noise is overlapped, a signal level shows probability distribution indicated by a continuous line in a case of “1” and probability distribution indicated by a dotted line in a case of “0”. Here, the legitimate receiver sets as a threshold value 1 a level which is sufficiently larger than an average level among levels, corresponding to “1”, of the received signal and beyond which there is little probability that a value is “0”.

And the legitimate receiver sets as a threshold value 0 a level which is sufficiently smaller than an average level among levels, corresponding to “0”, of the received signal and below which there is little probability that a value is “1”. The legitimate receiver identifies the received signal as “1” when the received signal is larger than the threshold 1 and as “0” when the received signal is smaller than the threshold 0, and determines a value of the received signal as being unidentified when the received signal is between levels of the thresholds 1 and 0 and discards bits contained in the received signal. The legitimate receiver sends back to the transmitter a position of bits with which identification has succeeded so that the transmitter and the legitimate receiver share the position of the bits as a key. Although it is likely that the legitimate receiver may infrequently make erroneous identification of a received signal, error correction code or the like can be used to cope with the erroneous identification.

On the other hand, since a reception level of the eavesdropper shows probability distribution similar to that of the legitimate receiver, it is possible for the eavesdropper to try similar identification, however, because of no correlativity between signal levels of the legitimate receiver and the eavesdropper, a position of bits with which identification succeeds is different. Therefore, the eavesdropper cannot share the key. And if the eavesdropper identifies, as a threshold value, a middle level between average levels among levels corresponding to “1” and levels corresponding to “0”, because probability distribution of signal levels is beyond the middle level, bit error may occur with strong probability and a bit sequence of the key which the eavesdropper can obtain becomes erroneous. This realizes safe key distribution.

Next, operations of respective sections of the present embodiment will be described with reference to FIG. 1. In FIG. 1, based on predetermined first key information, the first multi-level code generation section 111a generates a multi-level code sequence 12 in which the signal level changes so as to be substantially random numbers. A multi-level code sequence 12 and information data 10 are inputted to the multi-level processing section 111b. In accordance with predetermined procedures, the multi-level processing section 111b combines the multi-level code sequence 12 and the information data 10, generates and outputs a multi-level signal 13 having a level uniquely corresponding to a combination of both signal levels. The modulator section 112 converts the multi-level signal 13 as original data to a modulated signal 14 which is modulated in a predetermined modulation method and outputs a resultant to the transmission line 110.

The demodulator section 211 demodulates the modulated signal 14 transmitted via the transmission line 110 and regenerates a multi-level signal 15. The second multi-level code generation section 212a previously holds second key information 16 whose content is same as the first key information 11 and based on the second key information 16, generates a multi-level code sequence 17 corresponding to the multi-level code sequence 12. The multi-level identification section 212b performs identification of the multi-level signal 15 (binary determination) using the multi-level code sequence 17 as a threshold value and regenerates information data 18. Here, the modulated signal 14 modulated in the predetermined modulation method, which is transmitted and received via the transmission line 110, is obtained by modulating a electromagnetic wave (electromagnetic field) or a light wave using the multi-level signal 13.

A generation method of the multi-level signal 13 in the multi-level processing section 111b may be any method such as the above-mentioned method by adding-processing of the multi-level code sequence 12 and the information data 10; a method in which a level of the multi-level code sequence 12 is amplitude-modulated/controlled in accordance with the information data 10; a method in which in accordance with both signal levels, i.e., the multi-level code sequence 12 and the information data 10, multi-level signal levels corresponding to a combination of the both signal levels are consecutively read out from a memory having previously stored therein the multi-level signal levels corresponding to the combination of the both signal levels; or the like.

The random number generation section 151 generates a random number signal 84 to be outputted to the first multi-level code generation section 111a and the key accumulation control section 1501. Based on not only the first key information 11 but also a value of the random number signal 84, the first multi-level code generation section 111a generates the multi-level code sequence 12 to be outputted to the multi-level processing section 111b.

The first key sharing section 150 and the second key sharing section 250 share bits, in the transmitted random number signal 84, with which identification has succeeded and retains a resultant as new key information. Hereinafter, details will be described. The key identification section 2501 identifies the random number signal 84 from the multi-level signal 15; if the identification succeeds, outputs a resultant as selected bits 88 to the key accumulation section 2503; and outputs a position of the bits, with which the identification has succeeded, as a selected signal 89 to the selected-signal modulator section 2502. The second key accumulation section 2503 has a function of retaining a value of the second key information 16 and outputting the value of the second key information 16 to the multi-level code generation section 212a and a function of accumulating the selected bits 88. And when a predetermined condition is satisfied, the second key accumulation section 2503 replaces the value of the second key information with the selected bits 88.

The predetermined condition may be a condition that a number of the selected bits 88 accumulated reaches a number of the bits of the second key information 16 or a condition that a predetermined time has passed since previous replacement of the key information. The selected-signal modulator section 2502 modulates the selected signal 89 to a selected modulated signal 87 in a predetermined modulation method, to be transmitted via the selected-signal transmission line 152. As the selected-signal transmission line 152, any transmission line may be used. For example, a transmission line in a direction opposite to the transmission line 110 may be multiplexed or a dedicated transmission line may be used.

The selected-signal demodulator section 1502 demodulates the selected modulated signal 87, transmitted via the selected-signal transmission line 152, to be outputted as a selected signal 85 to the key accumulation control section 1501. The key accumulation control section 1501 retains the value of the random number signal 84 until the selected-signal 85 is sent back and when it is determined based on information of the selected-signal 85 that the identification has succeeded at a reception end, outputs, as selected bits, a value of bits of the random number signal 84 to the first key accumulation section 1503.

On the other hand, when it is determined that the identification has failed at a transmission end, the key accumulation control section 1501 discards the bits of the random number signal 84. The first key accumulation section 1503 has a function of retaining a value of the first key information 11 and outputting to the multi-level code generation section 111a the value of the first key information 11 and a function of accumulating selected bits 86. And when a same predetermined condition as that of the second key accumulation section 2503 is satisfied, the first key accumulation section 1503 replaces the value of the first key information 11 with a value of the selected bits 86 accumulated.

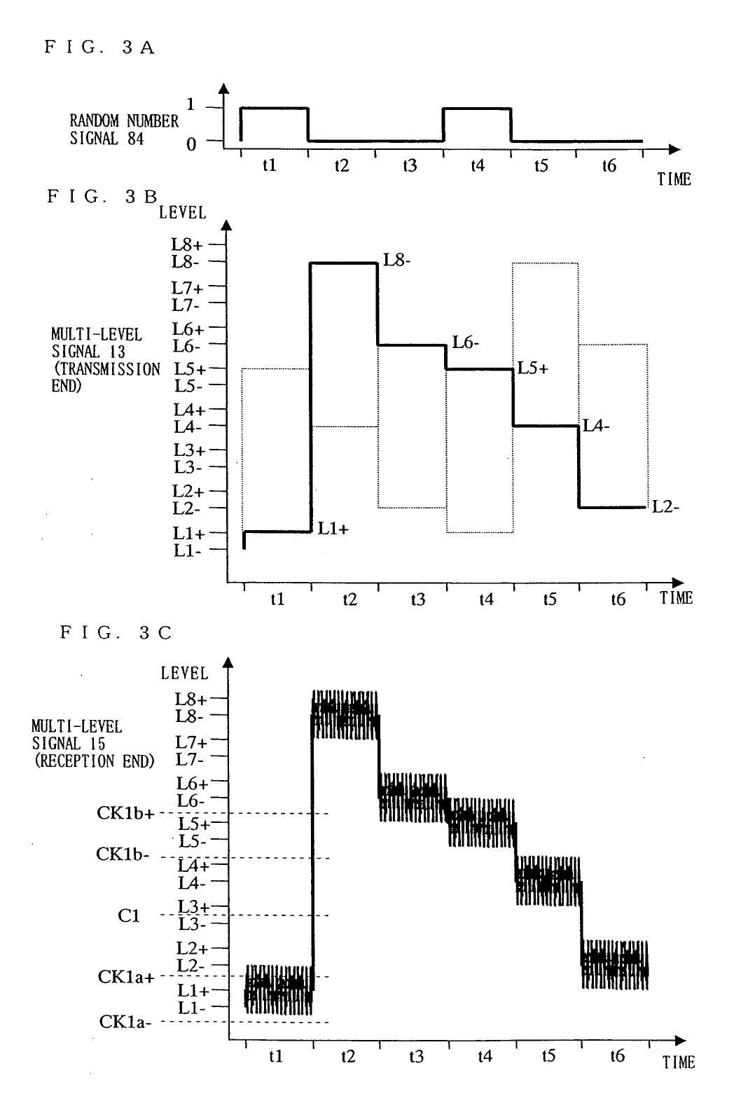

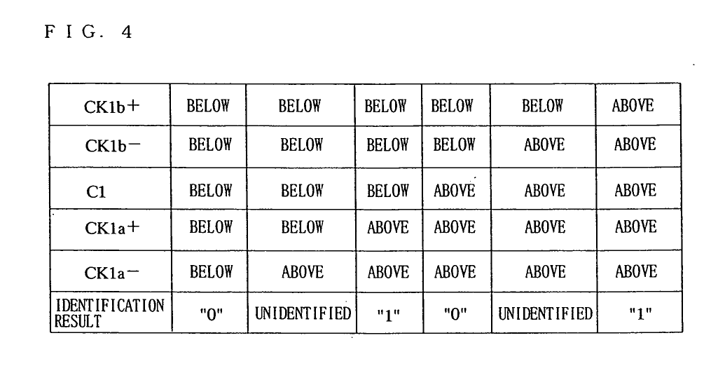

Next, with reference to FIGS. 3A, 3B, and 3C, and FIG. 4, signals used in the present embodiment will be described. FIGS. 3A, 3B, and 3C are diagrams explaining waveforms used in the data communications device according to the first embodiment. As shown in FIG. 3A, a case where a value of the random number signal 84 is “100100” is considered. As shown in FIG. 3B, when the multi-level signal 13 takes 8 kinds of levels based on the information data 10 and the first key information 11, the multi-level encoding section 111 sets levels (respectively shown by “+” and “−”) respectively corresponding to values “1” and “0” of the random number signal 84 and sets a total of 16 kinds of levels.

Here, a difference between levels (for example, L1+ and L1−) corresponding to the values “1” and “0” of the random number signal 84 are set so as to be smaller than a quantum noise level or a noise level generated in the demodulator section 211 and to be sufficiently smaller than a difference between information amplitudes (for example, L1+ and L5+). Thus, the multi-level signal 13 satisfies a condition of a signal level in the above-mentioned Yuen-Kim key distribution protocol and a difference between levels of the multi-level signal 13 can be disregarded as an error upon the identification in the multi-level identification section 212b.

At the reception end, as shown in FIG. 3C, a demodulated multi-level signal 15 is in a state where noise is overlapped thereon. In the key identification section 2501, the random number signal 84 is identified by using a level of a multi-level code sequence 17 generated based on second key information 16 and a key identification level generated based on the multi-level code sequence 17. This identification method will be described by using an example of a period t1 (a level C1 of the multi-level code sequence). Here set are 4 kinds of key identification levels: “CK1a+”, “CK1a−”, “CK1b+”, and “CK1b−”. The levels “CK1a+” and “CK1b−”correspond to a threshold value 1 in FIG. 2. The levels “CK1a+” and CK1b−” correspond to a threshold value 0 in FIG. 2. The levels “CK1a+” and CK1a−” correspond to a value “0”of the information data 18. The levels “CK1b+” and “CK1b−” correspond to a value “1” of the information data 18.

FIG. 4 is a diagram showing a relationship of correspondence between a relative value of a received signal level of each identification level and an identification result. In FIG. 4, “above” shows that the received signal level is larger than the identification level and “below” shows that the received signal level is smaller than the identification level. When the received signal level is smaller than a multi-level code sequence level C1, since the information data 18 corresponds to “0”, the key identification section 2501 performs the identification for the random number signal by using “CK1a+” and “CK1a−”. When a signal level is larger than “CK1a+”, the key identification section 2501 identifies the random number signal as “1”; when the signal level is smaller than “CK1b−”, the key identification section 2501 identifies the random number signal as “0”; and when the signal level is between “CK1a+” and “CK1a−”, the key identification section 2501 determines the random number signal as being unidentified.

On the other hand, when the received signal level is smaller than a multi-level code sequence level C1, since the information data 18 corresponds to “1”, the key identification section 2501 performs the identification for the random number signal by using “CK1b+”and “CK1b−”. When a signal level is larger than “CK1b+”, the key identification section 2501 identifies the random number signal as “1”; when the signal level is smaller than “CK1b−”, the key identification section 2501 identifies the random number signal as “0”; and when the signal level is between “CK1b+” and “CK1b−”, the key identification section 2501 determines the random number signal as being unidentified. Similarly, based on levels of the multi-level code sequence 17 in respective periods, the key identification section 2501 sets key identification levels and performs the identification for the random number signal.

The method above described is a method for transmitting a random number signal in a case where the key information which has already been used is updated to new key information. In a case of distributing a first key, only 2 predetermined adjacent multi-level signal levels (for example, L1+ and L1−) are used without data transmission and the random number signal is transmitted. Thus, the method of the present embodiment is applicable in both cases where the key information used first is distributed and where for some reasons (loss of synchronization of key information, safety improvement needed or the like), updating the key information is desired.

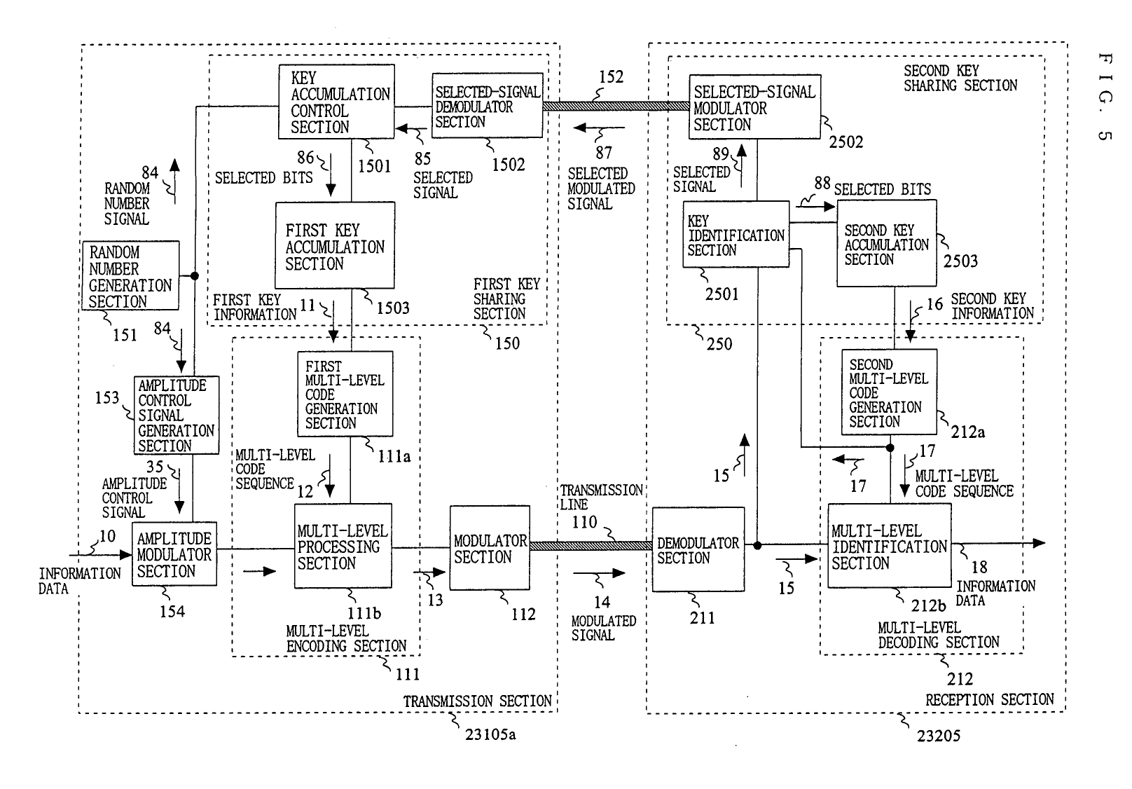

The processing described above may be realized if the transmission section 23105 has a different configuration. Some examples will be described. FIG. 5 is a block diagram illustrating a second exemplary configuration of the data communications device according to the first embodiment. In FIG. 5, the configuration of the transmission section 23105a is different from that shown in FIG. 1 in that an amplitude control signal generation section 153 and an amplitude modulator section 154 are included. In this example of the configuration, the random number signal 84 is inputted to the amplitude control signal generation section 153 instead of the first multi-level code generation 111a. Based on a random number signal 80, the amplitude control signal generation section 153 outputs an amplitude control signal 35 which determines an amplitude of the information data 10. Upstream of the multi-level processing section 111b, the amplitude modulator section 154 is inserted and performs, based on the amplitude control signal 35, smaller amplitude modulation than noise level for the information data 10 to be outputted. Thus, the multi-level processing 111b can generate a multi-level signal 13 similar to that shown in FIG. 3B.

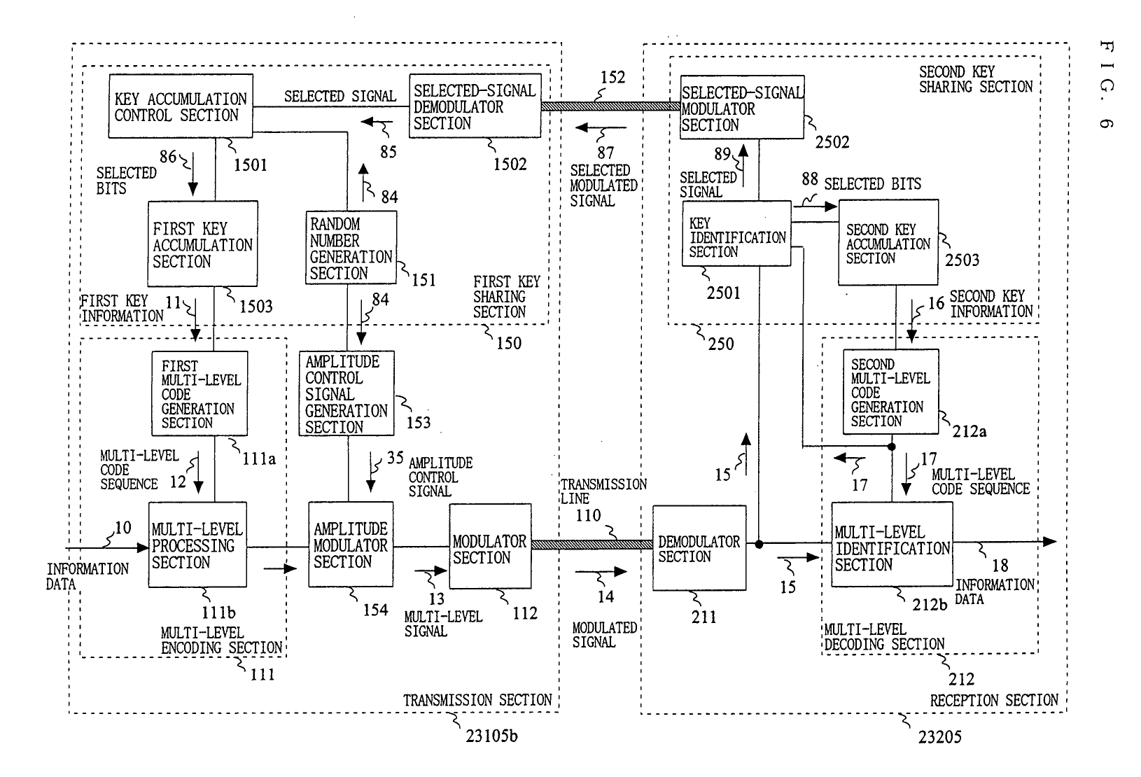

FIG. 6 is a block diagram illustrating a third exemplary configuration of the data communications device according to the first embodiment of the present invention. The present exemplary configuration is different from that shown in FIG. 5 in that the amplitude modulator section 154 is inserted between the multi-level processing section 111b and the modulator section 112. In this case, the amplitude modulator section 154 performs smaller amplitude modulation than noise level for the multi-level signal 13 to be outputted.

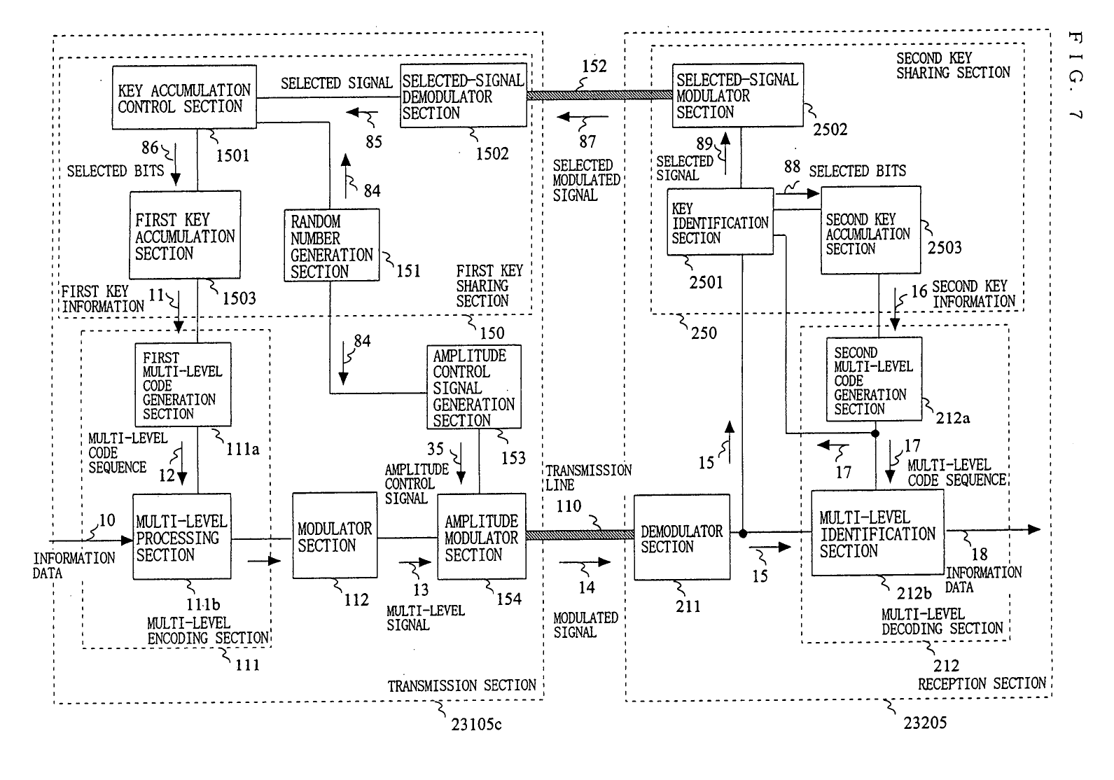

FIG. 7 is a block diagram illustrating a fourth exemplary configuration of the data communications device according to the first embodiment of the present invention. The present exemplary configuration is different from that shown in FIG. 5 in that the amplitude modulator section 154 is inserted downstream of the modulator section 112. In this case, the amplitude modulator section 154 performs smaller amplitude modulation than noise level for the multi-level signal 14 to be outputted.

As described above, according to the present embodiment, transmission of cipher text and distribution of an encryption key can be realized by using the common transmission section and the common reception section, thereby requiring no preparation of a separate encryption key distribution system and allowing a configuration of a secret communications system to be simplified.

(Second Embodiment)

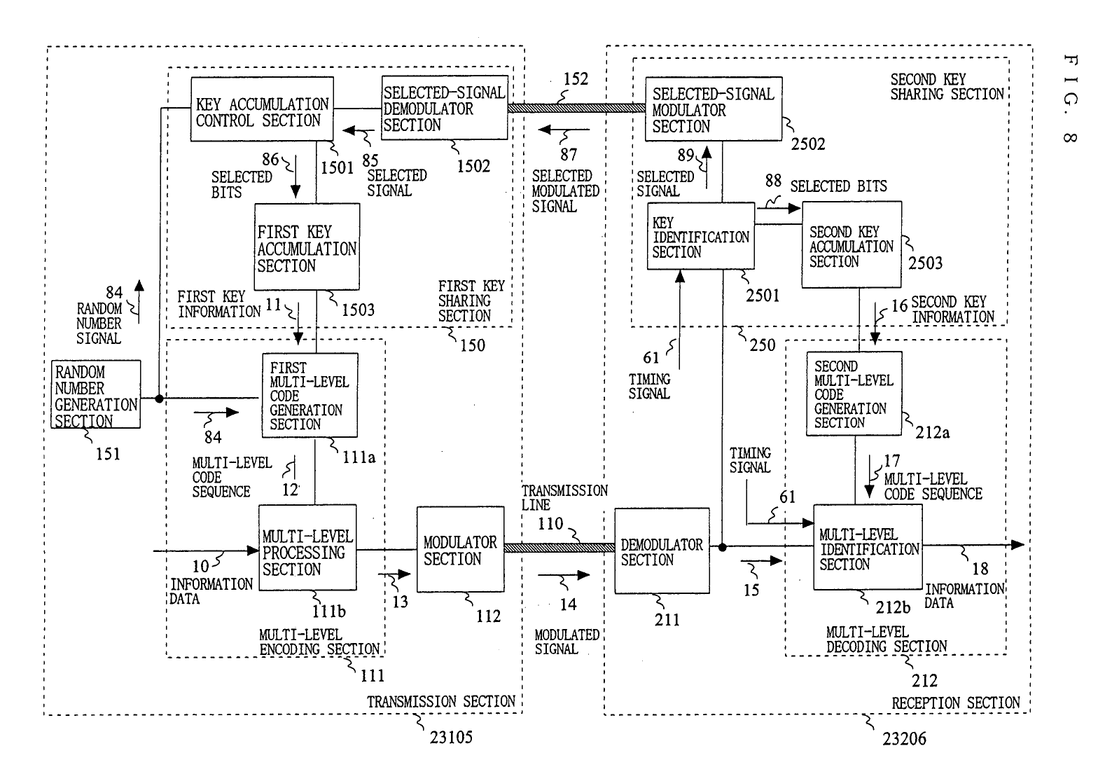

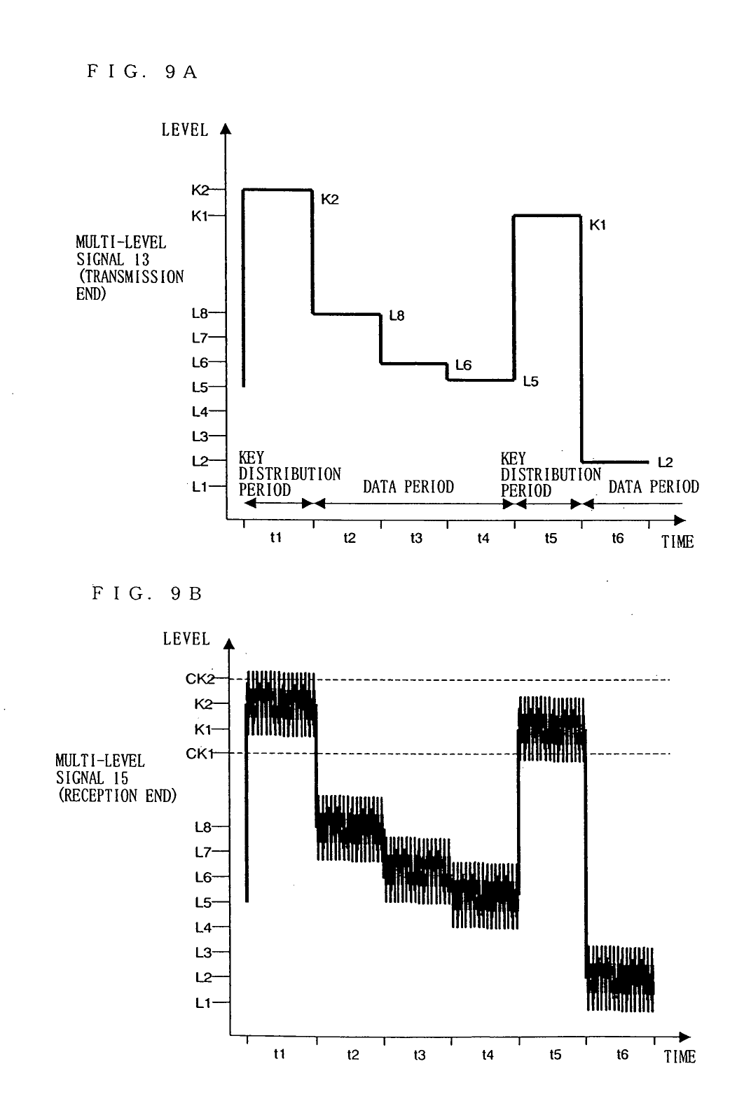

FIG. 8 is a block diagram illustrating an exemplary configuration of a data communications device according to a second embodiment of the present invention. Although the configuration of the data communications device shown in FIG. 8 is basically similar to that shown in FIG. 1 (of the first embodiment), the configuration of the second embodiment is different from that of the first embodiment in that the multi-level code sequence 17 outputted from a second multi-level code generation section 212a is not inputted to the key identification section 2501, but a timing signal 61 is inputted to the key identification section 2501 and the multi-level identification section 212b. In the present embodiment, a data transmission period is time-divided into a data period of transmitting a cipher and a data period of transmitting a key. With reference to FIGS. 9A and 9B, signal forms in the present embodiment will be described.

FIGS. 9A and 9B are diagrams illustrating signal waveforms used in the data communications device according to the second embodiment. As shown in FIG. 9A, in the multi-level signal 13 of the key distribution period (t1), a level dedicated for the key distribution is set, a level corresponding to a value “1” of the random number is K2, and a level corresponding to a value “0” of the random number is K1. Here, a difference between K2 and K1 is set so as to be sufficiently smaller than a level of a quantum noise or a level of noise generated in the demodulator section 211. Since values which are set in the data period are same as in the first embodiment, description on the values will be omitted.

At the reception end, as shown in FIG. 9B, noise is overlapped on the multi-level signal 15. The key identification section 2501 performs key identification in a period in which the timing signal 61 is being inputted, which indicates a key distribution period. A key identification level CK2 (corresponding to a threshold value 1 in FIG. 2) corresponding to “1” of the random number signal is set so as to be sufficiently larger than an average level K2 and a key identification level CK1 (corresponding to a threshold value 0 in FIG. 2) corresponding to “0” of the random number signal is set so as to be sufficiently smaller than an average level K1. When a signal level of the multi-level signal 15 is larger than CK2, the key identification section 2501 identifies the random number signal as “1”; when the signal level of the multi-level signal 15 is smaller than CK2, the key identification section 2501 identifies the random number signal as “0” ; and when the signal level of the multi-level signal 15 is between CK2 and CK1, the key identification section 2501 determines the random number signal as being unidentified.

The multi-level identification section 212b determines the data period based on the timing signal 61 and performs identification for information data in the period. Since operations by respective sections other than the above-mentioned operation are same as in the first embodiment, descriptions on the operations will be omitted.

Although in FIGS. 9A and 9B, a case where the multi-level signal level of the key distribution period is set to a value different from that of the data period is described, the multi-level signal level of the key distribution period may be set to a same value as that of the data period. A ratio of the key distribution period to the data period can be arbitrarily set according to requirement of a communication system. For example, if importance is attached to enhancement of safety by increasing a frequency of key replacement, a long key distribution period may be set and if importance is attached to an increase in throughput of the information data, a long data period may be set.

As described above, according to the second embodiment of the present invention, effect similar to that in the first embodiment can be obtained without controlling identification levels in the key identification section 2501 in a complex manner.

(Third Embodiment)

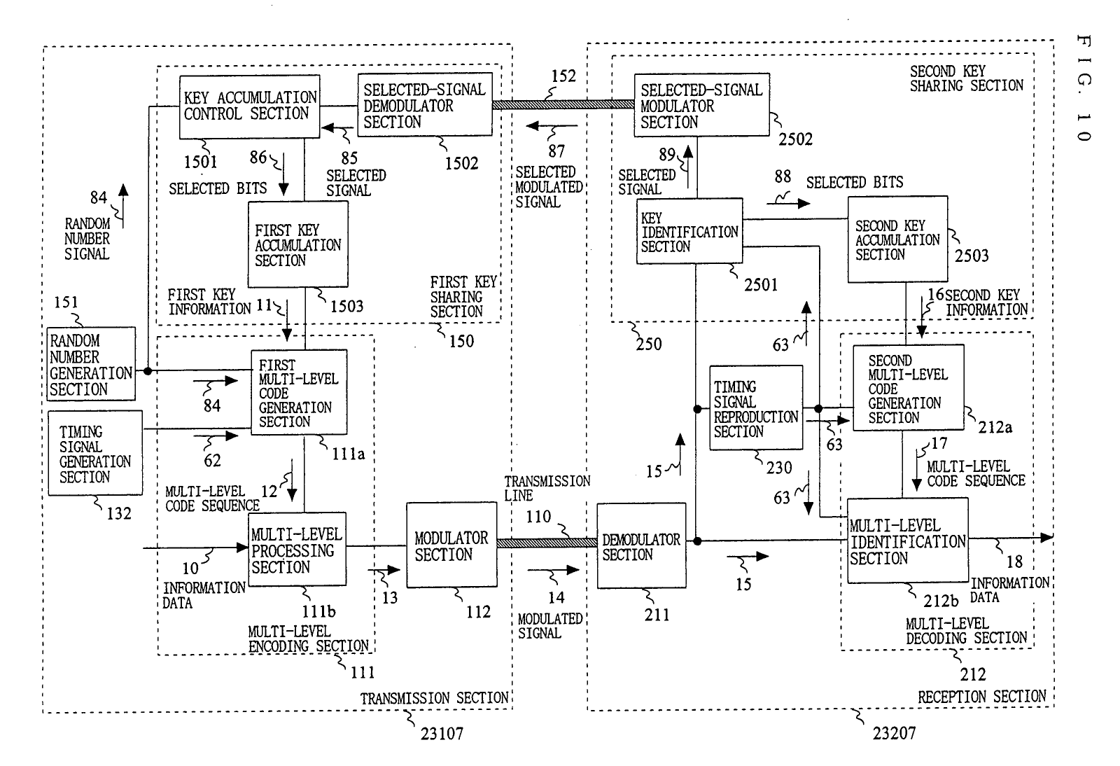

FIG. 10 is a block diagram illustrating an exemplary configuration of a data communications device according to a third embodiment of the present invention. The data communications device, in the configuration shown in FIG. 8, further includes a timing signal generation section 132 inside of the transmission section 23107 and a timing signal reproduction section 230 inside of the reception section 23207. The timing signal generation section 132 generates a timing signal 62. The timing signal 62 is a signal whose frame clock or data clock is amplitude-divided. The timing signal reproduction section 230 reproduces the timing signal 63 from the multi-level signal 15.

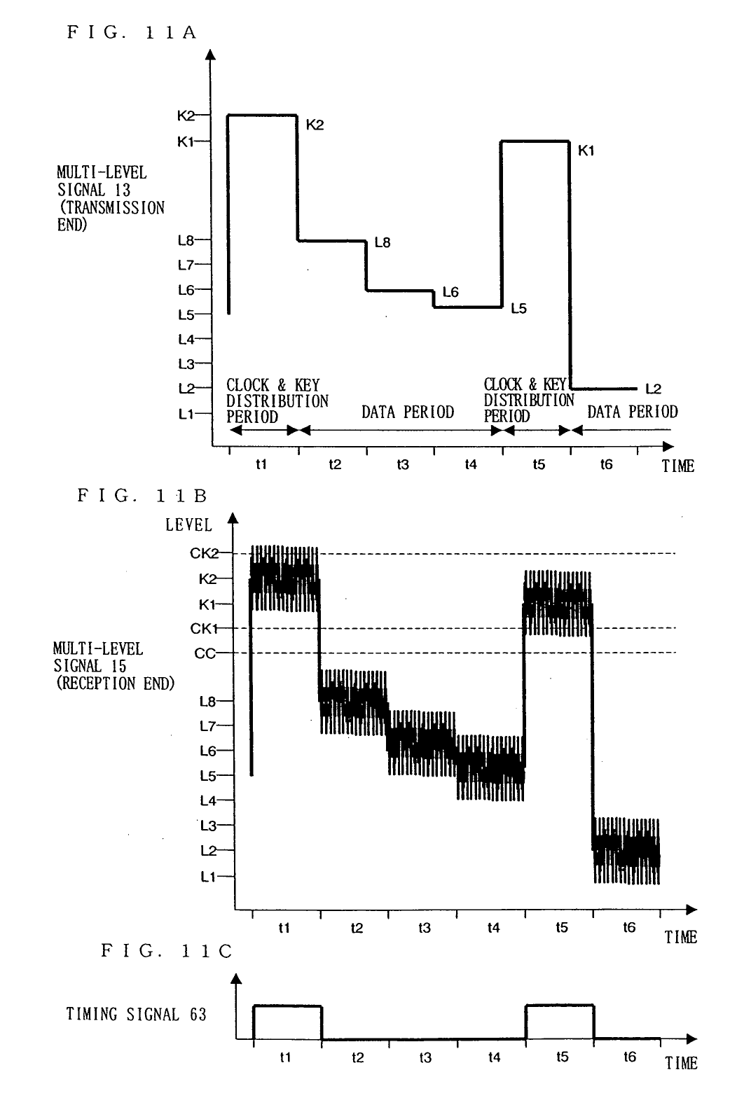

In the configuration of the present embodiment, the timing signal, in addition to the cipher text and the encryption key, is transmitted. With reference to FIGS. 11A, 11B, and 11C, signal forms in the present embodiment will be described. FIGS. 11A, 11B, and 11C are diagrams explaining signal waveforms used in the third embodiment of the present invention. FIGS. 11A, 11B, and 11C show an example in which the timing signal transmission and the key distribution are performed at simultaneous timing. The multi-level encoding section 111 sets a level of the multi-level signal to a dedicated level in a period in which the timing signal is transmitted and a key is distributed. Since the modulation and the identification of the random number signal are same as those described with reference to FIGS. 9A and 9B, description on the modulation and the identification of the random number signal will be omitted. The timing signal reproduction section 230 sets a timing signal identification level CC between a multi-level signal level in the data period and a multi-level signal level in the period in which the timing signal is transmitted and the key is distributed and performs the identification for the multi-level signal 15. Thus, the timing signal reproduction section 230 can obtain the timing signal 63 shown in FIG. 11C. This timing signal 63 is used as a reference of a clock signal used in the multi-level encoding section 212 and the key identification section 2501.

Although in FIGS. 11A, 11B, and 11C, an example in which the key distribution is performed only in a period in which the timing signal is transmitted, the key distribution can be performed also in the data period if the method described in the first embodiment is used.

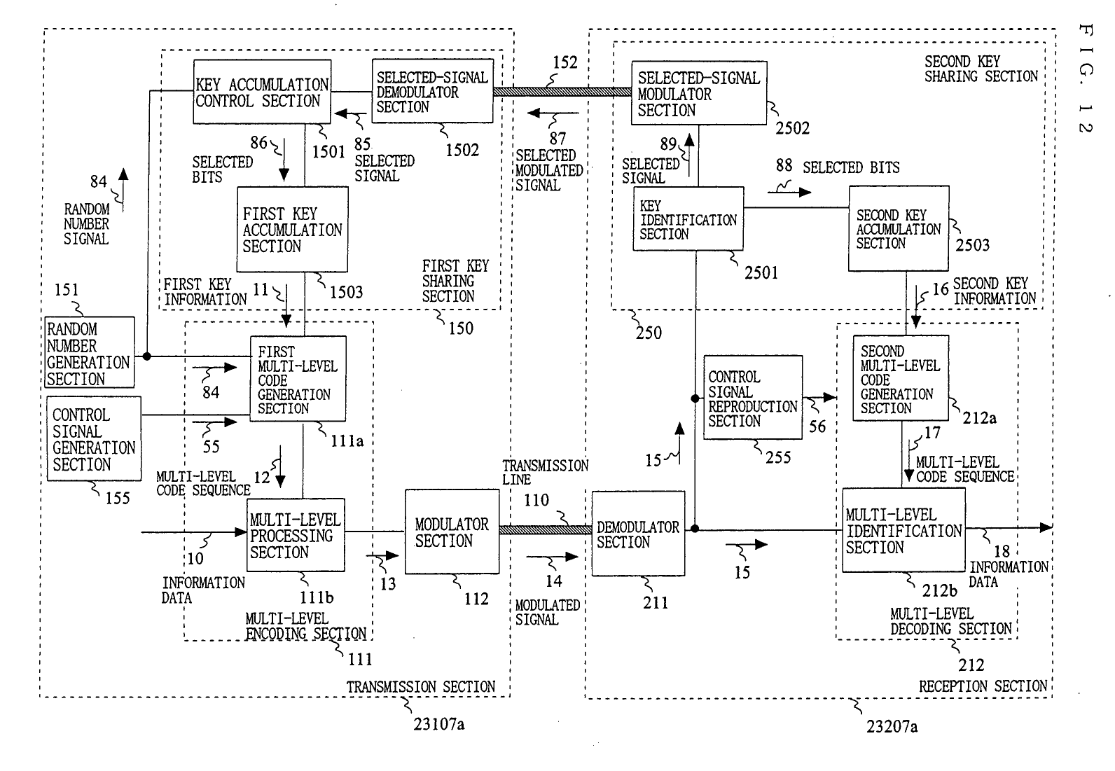

In addition, although in the data communications device described above, an example in which the timing signal is transmitted is shown, not only the timing signal but also various kinds of a control signal can be transmitted by using a similar method. FIG. 12 is a block diagram illustrating a second exemplary configuration of the data communications device according to the third embodiment. In FIG. 12, a transmission section 23107a includes, instead of the timing signal generation section 132, a control signal generation section 155 which generates a control signal 55 and a reception section 23207a includes, instead of the timing signal reproduction section 230, a control signal reproduction section 255 which reproduces a control signal 56 from the multi-level signal 15.

As described above, according to the present embodiment, common transmission and reception sections can transmit various control signals such as the timing signal, in addition to the cipher text and the encryption key.

The data communications device according to the present invention is useful as a secret communications device or the like which does not accept any eavesdropping, interception or the like.

While the invention has been described in detail, the foregoing description is in all aspects illustrative and not restrictive. It is understood that numerous other modifications and variations can be devised without departing from the scope of the invention.

What is claimed is:

1. A data transmission apparatus for performing secret communication of information data, comprising:
a multi-level code generation section for, by using predetermined key information, generating a multi-level code sequence in which a signal level changes so as to be substantially random numbers;
a multi-level processing section for combining the multi-level code sequence and the information data in accordance with predetermined processing and generating a multi-level signal having a level corresponding to a level of a combination of the multi-level code sequence and the information data;
a modulator section for generating a modulated signal in a predetermined modulation method based on the multi-level signal;
a random number generation section for generating a random number signal; and
a key sharing section for selecting a part of bits from the random number signal based on a selected modulated signal transmitted from a reception end, accumulating the selected bits, and when a predetermined condition is satisfied, outputting the selected bits as new key information, wherein
the modulated signal is amplitude-modulated based on the random number signal in a predetermined period.

2. The data transmission apparatus according to claim 1, wherein the key sharing section comprises:
a selected-signal demodulator section for demodulating the selected modulated signal, in the predetermined modulation method, to be outputted as a selected signal;
a key accumulation control section for selecting a part of bits from the random number signal based on the selected signal and outputting the selected bits; and
a key accumulation section for outputting the key information, accumulating the selected bits, and when a predetermined condition is satisfied, outputting the selected bits as new key information.

3. The data transmission apparatus according to claim 1, further comprising
an amplitude control signal generation section for outputting an amplitude control signal, based on the random number signal, which determines an amplitude of the information data, and
an amplitude modulator section, which is provided upstream of the multi-level processing section, for amplitude-modulating the information data, based on the amplitude control signal, to be outputted.

4. The data transmission apparatus according to claim 1, further comprising
an amplitude control signal generation section for outputting an amplitude control signal, based on the random number signal, which determines an information amplitude of the multi-level signal, and
an amplitude modulator section, which is provided between the multi-level processing section and the modulator section, for amplitude-modulating the multi-level signal, based on the amplitude control signal, to be outputted.

5. The data transmission apparatus according to claim 1, further comprising
an amplitude control signal generation section for outputting an amplitude control signal, based on the random number signal, which determines an information amplitude of the modulated signal, and
an amplitude modulator section, which is provided downstream of the modulator section, for amplitude-modulating the modulated signal, based on the amplitude control signal, to be outputted.

6. The data transmission apparatus according to claim 1, wherein a magnitude of an amplitude modulation based on the random number signal is sufficiently smaller than the information amplitude of the multi-level signal.

7. The data transmission apparatus according to claim 1, wherein the predetermined period is a same period as a period in which the information data is transmitted.

8. The data transmission apparatus according to claim 1, further comprising a control signal generation section for outputting to the multi-level code generation section a control signal of a predetermined type.

9. A data reception apparatus for performing secret communication of information data, comprising
a demodulator section for receiving from a transmission end a modulated signal in a predetermined modulation method, demodulating the received modulated signal, and outputting a multi-level signal;
a multi-level code generation section for, by using predetermined key information, generating a multi-level code sequence in which a signal level changes so as to be substantially random numbers;
a multi-level identification section for identifying the multi-level signal based on the multi-level code sequence and for outputting the information data; and
a key sharing section for attempting identification of a random number signal generated at the transmission end from the multi-level signal in a predetermined period, accumulating, when the identification succeeds, a resultant as selected bits, outputting, when a predetermined condition is satisfied, the selected bits as new key information, and outputting to the transmission end a selected modulated signal indicating a position of the bits with which the identification has succeeded.

10. The data reception apparatus according to claim 9, wherein the key sharing section comprises:
a key identification section for attempting identification of the random number signal from the multi-level signal in a predetermined period, and outputting, when the identification succeeds, a resultant as selected bits, and outputting a selected modulated signal indicating a position of the bits with which the identification has succeeded;
a key accumulation section for outputting the key information, accumulating the selected bits, and when a predetermined condition is satisfied, outputting the selected bits as new key information; and
a selected-signal modulator section for modulating the selected signal, in a predetermined modulation method, to be outputted as a selected modulated signal.

11. The data reception apparatus according to claim 9, wherein a magnitude of amplitude modulation based on the random number signal is sufficiently smaller than an information amplitude of the multi-level signal.

12. The data reception apparatus according to claim 9, wherein the predetermined period is a same period as a period in which the information data is transmitted.

13. The data reception apparatus according to claim 9, further comprising a control signal reproduction section for reproducing a control signal of a predetermined type from the multi-level signal.
